(19) United States
(12) Patent Application Publication
(10) Pub. No.: US 2026/0176138 A1
(43) Pub. Date: Jun. 25, 2026

(54) PROCESS TO CONTROL THE OUTLET TEMPERATURE OF A HEAT EXCHANGE REFORMER IN SYNGAS PRODUCTION FOR CHEMICAL AND FUEL INDUSTRIES

(71) Applicant: TOPSOE A/S, Kgs. Lyngby (DK)

(72) Inventors: Kaushal DHYANI, Delhi (IN); Claus Fallesen HANSEN, Hørsholm (DK); Sanghdeep GAUTAM, Uttar Pradesh (IN)

(73) Assignee: TOPSOE A/S, Kgs. Lyngby (DK)

(21) Appl. No.: 19/127,634

(22) PCT Filed: Nov. 10, 2023
(86) PCT No.: PCT/EP2023/081468

§ 371 Date: May 6, 2025

(30) Foreign Application Priority Data
Nov. 11, 2022 (IN) 202211064722
Feb. 28, 2023 (DK) PA202300183

(51) Int. Cl. C01B 3/56; C01B 3/38; C01B 3/382; C01B 3/384; C01B 3/48

(52) U.S. Cl. CPC C01B 3/56; C01B 3/38; C01B 3/382; C01B 3/384; C01B 3/48; C01B 2203/0233

(57) ABSTRACT

A process to control the outlet temperature of a heat exchange reformer in the production of synthesis gas wherein a first stream of feed gas is directed to a first reforming section and a second stream of feed gas is directed to said heat exchange reformer, wherein the outlet stream of said reforming section is divided into at least a first and a second sub-streams. The first sub-stream is directed into said heat exchange reformer to provide heat for the reforming section and the outlet stream of the heat exchange reformer is directed to a first waste heat boiler. The second sub-stream bypasses the heat exchange reformer and is directed to a second waste heat boiler for heat recovery and high pressure steam production. The outlet temperature of said heat exchange reformer is adjusted in this manner.

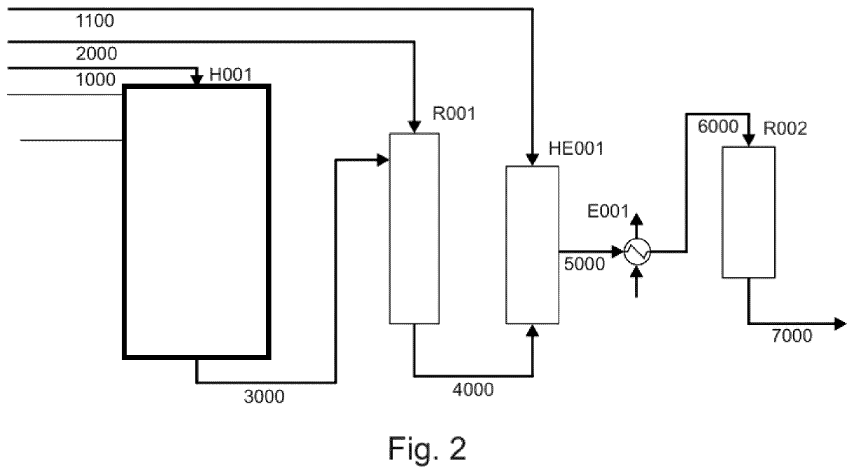

The present invention relates to a process for controlling the outlet temperature of a heat exchange reformer in syngas production and optionally of the inlet temperature of a reactor for production of chemicals and fuels, wherein different limitations of the conventional heat exchange reformer scheme (FIG. 2) are overcome, which is particularly useful when revamping existing plants for production of chemicals and/or fuels, such as ammonia and methanol plants.

### Background to Invention

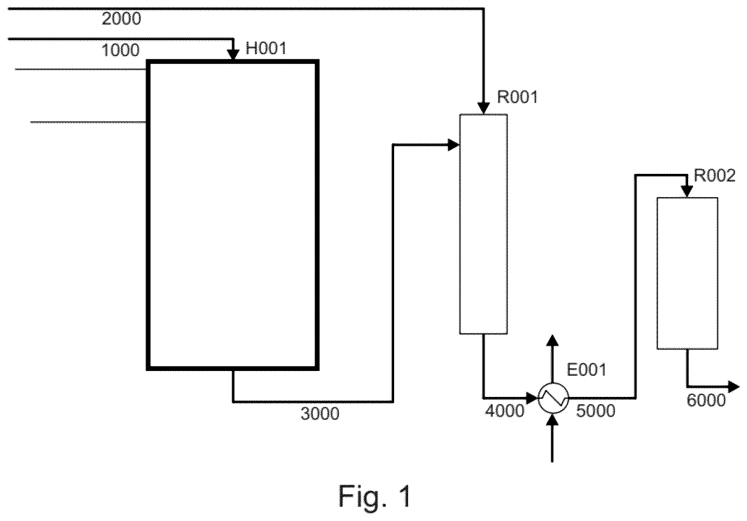

In conventional ammonia and methanol plants it is common to have one or two step-reforming, said reforming taking place in a reforming section comprising a primary reformer (H001), a secondary reformer (R001) or both (FIG. 1).

A parallel heat exchange reformer (HE001) can be introduced in ammonia or methanol plants (FIG. 2) to distribute the reforming load from the reforming section to said heat exchange reformer. This configuration (FIG. 2) is introduced in new ammonia and methanol plants to optimize the primary reformer size and reduce energy consumption. The configuration of FIG. 2 is also used in existing ammonia and methanol plants as a revamp option, when it is required to increase the capacity or decrease the energy consumption of plants.

In such conventional heat exchange reforming configuration (FIG. 2) control of the outlet temperature of syngas from heat exchange reformer, stream 5000, is quite critical due to different parameters. During revamp of existing plants the control of outlet temperature of syngas from heat exchange reformer (stream 5000) is limited due to, e.g., mechanical design of the available primary reformer and waste heat section, process requirements of minimum natural gas feed and fuel flow and minimum steam production requirements for reforming reaction and consumption in steam turbines-all these factors result in unoptimized design and operation.

In a standard parallel heat exchange reformer scheme (FIG. 2) the temperature of the outlet stream (5000) is controlled by the following ways:
1) Control of process feed gas 2 (1100);
2) Control of the outlet temperature at the reforming section, e.g., primary reformer;
3) Control of steam to carbon (S/C) ratio of inlet stream 1000 to reforming section and inlet stream 1100, to heat exchange reformer, both preferably between 0.5 and 5.

However, in the revamps of existing ammonia and/or methanol plants (FIG. 2) control of feed gas 2 (1100) to heat exchange reformer (HE001) and control of the outlet temperature (3000, 4000) at the reforming section becomes a limitation due to following reasons:

### 1) Fixed Primary Reformer (H001) Design:

a. To control the outlet temperature (5000) of heat exchange reformer HE001, the flow of stream 1100 is increased while designing the plant which leads to reduced duty requirement in the reforming section, e.g. the primary reformer;
b. In existing plants the reduction of duty in the reforming section, e.g. primary reformer is limited due to operational limitation of available burners, as established by their respective manufacturers;

### 2) Waste Heat Section (E001) Heat Profile Requirement:

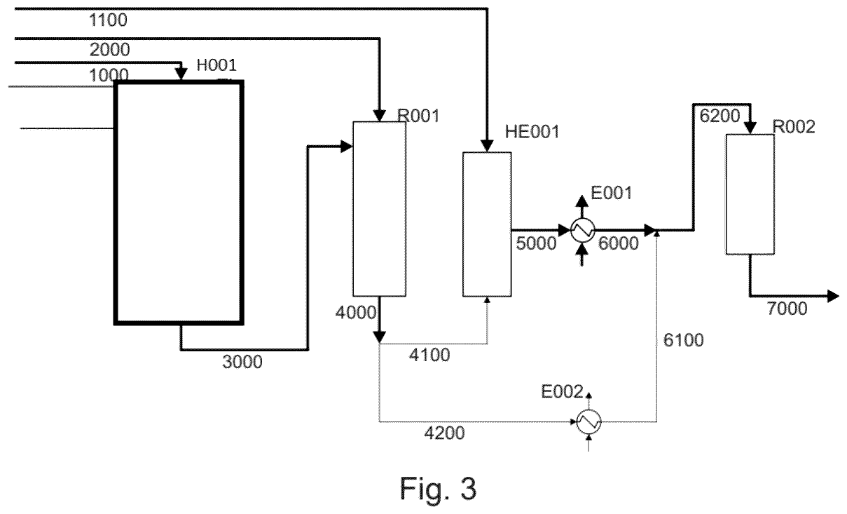

a. To control the outlet temperature (5000) of heat exchange reformer (HE001), flow of feed gas 2 (1100) is increased, which reduces the reforming section duty, e.g. of the primary reformer, by approximately 10 to 30%, such as 20% (FIG. 2) or 14% (FIG. 3), when compared to conventional reforming layout with primary/secondary reformer (FIG. 1);
b. Said reduced duty leads to an unoptimized bridge wall temperature, i.e., reduction in temperature of flue gas entering waste heat section by approximately 0.5 to 5%, such as 3% (FIG. 2) or 1% (FIG. 3), resulting in a poor waste heat section temperature profile;
c. In existing plants waste heat section duty requirement is fixed and modification is limited because of design and cost requirements.

### 3) Methane Slip Requirement

a. In existing plants when the parallel heat exchange reformer (HE001) is introduced, the flow of feed gas 2 (1100) to heat exchange reformer influences the outlet temperature of stream 5000.
b. Due to limitation in primary reformer burners, waste heat section and design temperatures of the reforming section, e.g., primary reformer/secondary reformer, the outlet temperature of heat exchange reformer (5000) remains lower than that required by design limitations which leads to higher methane slips and higher feed flows.

### 4) Steam Production Requirement:

a. The outlet stream from the reforming section, e.g., e.g. primary reformer (3000)—not shown—or secondary reformer (4000)—FIG. 3, goes to heat exchange reformer (HE001) for providing heat to the reforming reaction, thus the inlet temperature of waste heat boiler E001 is reduced by approximately 15%, when compared to the prior art;
b. In existing plants when the scheme of FIG. 2 is introduced, the outlet temperature of heat exchange reformer (5000) is further reduced by ˜3% due to inefficient control of outlet temperature because of limitations in the reforming section;
c. Lower heat exchange reformer outlet temperatures (5000) lead to lower duty of the waste heat boiler and lower steam production;
d. In existing ammonia and methanol plants lower steam production leads to more steam import into the steam system and overall higher energy consumption.

To address the above limitations, the present invention provides a process (FIG. 3) for controlling the outlet temperature of synthesis gas outlet (5000) of heat exchange reformer (HE001) in plants for production of chemicals and fuels, e.g. ammonia and methanol plants.

Said new process (FIG. 3) modifies the conventional heat exchange reforming scheme (FIG. 2) to overcome its limitations and provides different means to control the outlet temperature of heat exchange reformer. In this process a split (4100, 4200) is introduced at the outlet of a reforming section upstream to a heat exchange reformer (HE001) to utilize the heat of the process gas (4200) for generating more steam through waste heat boiler 2 (E002) and provide a new method to control the outlet temperature at the heat exchange reformer, as well as—optionally—control the inlet temperature at a reactor R002, downstream to said heat exchange reformer.

### DESCRIPTION

In conventional ammonia and methanol plants, reforming is commonly made in two steps, first in a primary reformer and then in a secondary reformer (FIG. 1).

A parallel heat exchange reformer is introduced in one or two-step reforming methanol and ammonia plants (FIG. 2) to distribute the reforming load from primary reformer to a heat exchange reformer. This scheme is introduced in new ammonia and methanol plants to optimize the primary reformer size and reduce energy consumption. This scheme is introduced in existing ammonia and methanol plants as a revamp option, when it is required to increase the capacity or decrease the energy consumption in plants. Here, the feed gas stream for reforming is split between one part (stream 1000) going to a reforming section, e.g. a primary reformer (H001) and another part (stream 1100) going to a heat exchange reformer (HE001). In heat exchange reformer (HE001) the process gas undergoes reforming reaction and heat for reforming is provided by the synthesis gas (stream 4000) at the outlet of reforming section, e.g. secondary reformer.

Control of temperature of synthesis gas (stream 5000) coming out of heat exchange reformer is quite critical and it impacts the following parameters:
1) Mechanical integrity of heat exchange reformer;
2) Design of heat exchange reformer with respect to its size/scale;
3) Reforming reaction and control of methane slip and thus feed flow;
4) Steam production in waste heat boiler E001;
5) Feed, fuel and steam production and consumption.

During revamps of existing e.g. 2 step reforming ammonia and methanol plants by introducing a heat exchange reformer (FIG. 2), due to different limitations, control and optimization of above parameters become difficult. To address these limitations a new process is provided in FIG. 3 and in the Example—C3, to control the heat exchange reformer outlet temperature by splitting the outlet stream (4000) of the reforming section in two separate streams (4100, 4200) and introducing a new waste heat boiler (E002) and a control means, e.g. a valve, downstream to E002 to control the outlet temperature at the heat exchange reformer.

### Definitions

Chemicals and fuels within the context of the present invention can be carbon monoxide, carbon dioxide, hydrogen, syngas, ammonia, methanol, ethanol, naphta, jet fuel, diesel, e-chemicals and e-fuels where an electrical reactor is used for their production, or other chemical or fuel obtainable by the process of the present invention. Here are included blue chemicals and fuels where carbon capture, reutilization or storage is combined with methods for their production. Green chemicals and fuels, where electrolysis of water or CO₂ and/or renewable sources of electricity such as wind, solar or geothermal power are used in their production are comprised within the scope of this definition.

Control means refers to an internal valve (or bypass valve) located in a waste heat boiler and also refers to a control valve, located downstream to a waste heat boiler.

In the present invention, the internal valves of waste heat boilers E001 and E002 are present and can be combined with at least one control valve downstream to one or both waste heat boilers, to adjust the outlet temperature of the heat exchange reformer.

Feed gas and Feed gas 2 comprise hydrocarbons, such as methane or natural gas, naphta, refinery off gases as well as any type of biomass or waste that can be converted into a fuel or chemical.

Heat exchange reformer (HE001) is a reformer which operates in series or in parallel with another reformer, such as an autothermal reformer (ATR) or a tubular reformer, and draws the necessary heat of reaction from the effluent gas from this source. Using a heat exchange reformer in an ammonia plant, in combination with a primary (A) and optionally a secondary (B) reformer can increase the reforming capacity by approximately 25%.

A very high reforming temperature above 1000° C. is usually required for providing low methane slippage, without operating at a high steam-to-carbon ratio (S/C).

A low methane slippage is crucial for ammonia plants as the methane will otherwise end up in the ammonia synthesis, affecting the rate of reaction.

The overall S/C in the ammonia plant with both primary/secondary reformer and a heat exchange reformer (e.g. HTER) is kept at the same level as for conventional plants with only a primary/secondary reformer. The low methane slippage is obtained with this technology, without increasing the outlet temperature from the primary reformer, because the required process air is still introduced in the secondary reformer (which leads to a lower methane slip from the secondary reformer), whereas only part of the feedstock passes through the primary and secondary reformer (Larsen, Henrik—Heat exchange reforming in gas synthesis, March 2012). Preferably, the inlet temperature at a heat exchange reformer HE001 varies between 300 and 500° C. and the outlet temperature between 500 and 900° C.

The steam methane reforming reaction is strongly endothermic and is therefore favored by a higher temperature. As the temperature is increased, the hydrogen yield increases, which is observed as a reduction in the methane concentration in the reformer effluent, known as methane slip. (from https://www.digitalrefining.com/article/1000339/optimised-hydrogen-production-by-steam-reforming-part-i #.Y2OYgXbMKUk).

An increased S/C (steam-to-carbon) ratio, as well as increased reformer outlet temperature, can contribute to reduce the methane slip.

Two-step reforming using a primary and a secondary reformers play an important role in the production of ammonia. The goal of reforming is to prepare as pure as possible a gas mixture of nitrogen and hydrogen in a 3:1 stoichiometric ratio from the raw materials of water, air, and natural gas. The reactions by which this ratio are achieved are given as follows:

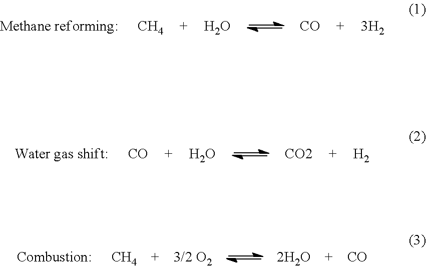

Reaction 1, the steam reforming reaction, and reaction 2, the water gas shift reaction, are endothermic and occur in the primary reformer (A). Reaction 3, the combustion reaction, is exothermic and occurs along with reactions 1 and 2 in the secondary reformer (B). Optimization of the reforming process involves the manipulation of parameters (such as temperature, pressure, steam to carbon ratio, and percent oxygen in the air feed) to achieve high process yield while maintaining low operating and installed costs.

Primary reformer inlet steam-to-carbon (s/c) ratio is an important factor in reformer design. Literature (https://www.owlnet.rice.edu/˜ceng403/nh3ref97.html) advises the maintenance of a relatively high s/c ratio to prevent mechanical as well as economic problems during the life of the plant. Higher s/c ratios are more effective for a number of reasons. First, because a high s/c ratio favors the products in the reforming reaction equilibrium, it lowers the amount of unreacted methane, or methane slip, out of the secondary reformer and increases the production of hydrogen. Second, a high s/c ratio inhibits the occurrence of carbon-forming side reactions in the primary reformer that result in carbon deposits on the catalyst. Carbon deposition increases the resistance to gas flow in the primary reformer tubes and may impair catalyst activity. This impairment lowers the rate of the reforming reaction and can cause local overheating or “hot bands” in reformer tubes that result in premature tube wall failure. Finally, a high s/c ratio provides the necessary steam for the shift conversion of carbon monoxide and reduces the risk of carburization damage to the tube material.

Oxygen-enriched air is sometimes utilized in the production of syngas as it shifts more of the reforming from the primary reformer to the secondary reformer. An increase in the proportion of reforming occurring in the secondary reformer results in a higher outlet temperature from the secondary reformer. This heat can be recycled and used to heat the primary reformer inlet stream to reduce energy costs. On the other hand, enriched air introduces another cost to the process by requiring that excess nitrogen be stripped from the process downstream or that excess oxygen be purchased from a third party supplier. It is important to note that the process is limited by a maximum pressure of 40 bar due to the metallurgy of the material used to construct the primary reformer tubes. High reformer pressures near 40 bar favour the reactants of the reforming reaction equilibrium, therefore, the production of hydrogen decreases while methane slip increases. To compensate for high methane slip the heat duty must be increased, thus increasing compression and energy costs. Higher pressures also cause the secondary reformer effluent temperature to decrease. This has an unfavourable effect on the process as the heat from this stream is used to heat the primary reformer inlet stream via heat exchanger. A lower pressure of 25 bar exerts a favourable effect on the equilibrium of the reforming process. Lower pressures increase secondary reformer outlet temperature, decrease methane slip to about 0.01%, and increase hydrogen production by approximately 100 kmol/hr.

It is not advisable to operate the primary reformer above 800 C because the metallurgy of the catalyst tubes causes them to creep and bulge under the weight of the catalyst at approximately 850 C. Additionally, the nickel catalyst melts at 1100 C. Operating at elevated temperatures also increases the heat duty, causing energy costs as well as equipment costs to escalate somewhat. In contrast, operating at 700 C decreases hydrogen production and increases methane slip out of the secondary reformer resulting in the waste of fuel. It is desirable to operate at a temperature as close to the metallurgical limit of 850 C as possible in order to maximize H2 production.

Primary and secondary reformer reactor sizes are calculated from industry data in order to minimize primary reformer size and thus minimize installed cost.

Reforming section comprises a primary reformer, a secondary reformer or both. Preferably, at a primary reformer H001, the inlet temperature range is between 500 to 700° C., the outlet temperature range is between 700 to 950° C. and at a secondary reformer R001 the inlet temperature is between 700 to 950° C. and the outlet temperature is between 900 to 1100° C.

A waste heat boiler uses the heat formed as a byproduct of another process, heat which would normally be wasted, and is instead used to create steam. The steam can be used to drive turbines which produce electricity. Alternatively, the boiler can simply be used to heat water or other fluids. As it recycles some of the energy used, a waste heat boiler, or waste heat recovery boiler, can reduce the fossil fuel consumption and financial running costs of a system. This also means fewer greenhouse gases are released into the atmosphere.

In a preferred embodiment of the present invention, the process in FIG. 3 is used in a new or revamped plant for production of ammonia.

In another preferred embodiment of the present invention, a similar process (not shown) to the one in FIG. 3 is used, where control of temperature in stream (5000) is achieved by splitting the reformed stream (3000) out of a reforming section, e.g. a primary reformer H001, into two different sub-streams, a first sub-stream being directed to the heat exchange reformer HE001 and a second sub-stream being directed to a waste heat boiler, in a new or revamped plant for production of methanol.

### DETAILED DESCRIPTION

For the revamp of existing 2 step reforming plants by including a heat exchange reformer, a new process (FIG. 3) has been introduced to control the heat exchange reformer outlet temperature:
1) In existing 2 step reforming plants a split of feed gas is taken (FIG. 3) with one stream 1000 going to primary reformer and the other stream 1100 going to heat exchange reformer.
2) The temperature of streams 1000 and 1100 are kept in the design limits of the reforming section, e.g. a primary reformer and heat exchange reformer
3) The amount of feed gas going to heat exchange reformer (stream 1100) is in range of approximately e.g. 10 to 15%.
4) Reformed gas stream 3000 from primary reformer H001 goes to secondary reformer R001.
5) Air or oxygen is added to secondary reformer R001 and stream 3000 is reformed. During revamp of existing e.g. ammonia and methanol plants due to the feed gas split taken to heat exchange reformer HE001 the oxygen to hydrocarbon ratio increases in secondary reformer and an exotherm is observed which leads to temperature rise of around 40 to 50° C.
6) In the new process (FIG. 3) stream 4000 is split to stream 4100 and stream 4200. Stream 4100 goes to heat exchange reformer HE001 to provide heat for reforming reaction and stream 4200 bypasses the heat exchange reformer and goes to a new waste boiler E002 for heat recovery and high pressure steam production.
7) Split to stream 4200 ranges approximately, e.g. 13 to 15% of total stream 4000 flow.
8) In the revamps of existing plants stream 5000 goes to an existing waste boiler and reduces the temperature of stream 5000 to temperature limits of a reactor R002.
9) Stream 4200 goes to a new waste heat boiler E002 and the temperature of stream 4200 is reduced to temperature limits of a reactor R002.
10) The split of the synthesis gas to the heat exchange reformer HE001 and waste heat boiler E002 is preferably controlled using a control valve downstream of waste heat boiler E002 on stream 6100.
11) The new process control scheme in FIG. 3 controls the temperature of stream 5000 by throttling the valve downstream of waste heat boiler E002.
12) In the revamps of existing plants of, e.g., ammonia and methanol the new process (FIG. 3) can be easily implemented similar to conventional heat exchange reformer revamp scheme (FIG. 2).

Streams 4000, 4100 and 4200 shall be refractory lined and stream 6000 and 6100 mixing will be like conventional stream mixing thus avoiding metal dusting issue. The parallel operation of stream 4100 and 4200 can be easily controlled using new control scheme. For the existing plants the existing waste heat boilers E001 can be easily integrated into the new process by creating a new connection downstream of existing secondary reformer R001.

### Effects and Advantages

The new process provided by the present invention (FIG. 3) involving bypass of heat exchange reformer HE001 has many advantages and overcomes different limitations of the conventional heat exchange reformer scheme (FIG. 2) while revamping existing plants for production of chemicals and/or fuels, in particular ammonia and methanol plants. Some of the advantages are as follows:

### 1) Optimizing the Design of Heat Exchange Reformer During a Plant Revamp

The new process (FIG. 3) involves taking lower feed gas split (about 4% lower flow rate in stream 1100) to heat exchange reformer to achieve same outlet temperatures compared to conventional heat exchange reformer scheme resulting in smaller size of heat exchange reformer.

The new process results in 30% less size in heat exchange reformer when compared with conventional heat exchange reformer (FIG. 2).

### 2) Maintaining Mechanical Integrity of Heat Exchange Reformer

During revamps of existing plants, the new process results in better control of heat exchange reformer outlet temperature

During normal operation and emergency scenarios the amount of synthesis gas bypassed in stream 4000 (refer FIG. 3) helps in maintaining the outlet temperature of heat exchange reformer below the mechanical design limit.

3) Overcoming the Limitations Due to Design of Existing Reforming Section, e.g. A Primary Reformer

In the new process the outlet temperature of stream 3000 or 4000 (FIG. 3) can be increased to the allowed limits for long term operation of the reforming section without impacting the heat exchange reformer outlet conditions as the heat exchange reformer outlet temperature is controlled by the flow to stream 4100 which is the synthesis gas stream used for providing heat for reforming reaction.

In the new process the flow in stream 4100 and stream 4200 is controlled by a new flow control valve.

As the outlet temperature of heat exchange reformer becomes independent of the outlet temperature at the reforming section, e.g. primary reformer, the duty of said reforming section can be maintained/optimized which results in optimized operation of the reforming section, e.g. the primary reformer and its burners.

### 4) Waste Heat Section Heat Profile Requirement

In the new process the outlet temperature of heat exchange reformer becomes independent of the outlet temperature of the reforming section, e.g. primary reformer. The duty in the reforming section and bridge wall temperature can be maintained leading to optimized heat profile in the waste heat section.

### 5) Methane Slip Requirement

The new process involves introducing a new heat exchange reformer configuration in existing 2 step reforming plants.

A part of feed gas is taken to heat exchange reformer HE001, stream 1100 which leads to increased oxygen to hydrocarbon ratio in existing secondary reformer.

The increase oxygen to hydrocarbon ratio and optimized outlet temperature of heat exchange reformer leads to lower methane slips compared to a conventional 2 step reforming plants.

Decrease of approximately e.g. 0.15 dry mole % methane slip and decrease in feed flow of around e.g. 2% is observed compared to conventional 2 step reforming solution.

### 6) Minimum Steam Production Requirement

In conventional heat exchange reformer scheme (FIG. 2) a part of feed stream 1100 is used as feed to heat exchange reformer and the synthesis gas from secondary reformer stream 4000 is used to provide heat for reforming reaction.

In the new process due to lower feed flow in stream 1100 compared to conventional heat exchange reformer scheme the heat requirement is lower. So stream 4200 heat is used to generate high pressure steam in new waste heat boiler E002.

In the new process the overall high pressure process steam production is approximately e.g. 15 tons more than conventional heat exchange reformer scheme (FIG. 2 and FIG. 3), the new process being able to balance the production of steam from an existing plant.

In the revamp of existing plants the existing boiler E001 can be easily integrated with the new process.

### 7) Overall Energy Consumption

For the revamps of existing plants of, e.g., ammonia and methanol, the new process results in about e.g. 0.06 Gcal/MT of energy saving compared to conventional heat exchange reformer scheme (FIG. 2 and FIG. 3)

### 8) Better Process Control During Emergency Scenarios

During emergency scenarios steam in conventional heat exchange reformer scheme (FIG. 2) is purged into the reforming section, e.g., secondary reformer. For a short interval of time the heat exchange reformer sees high temperature gases entering, which can lead to mechanical failure of heat exchange reformer.

In the new process (FIG. 3) this scenario can be avoided and the hot gases going to the heat exchange reformer from the reforming section can be minimized by shifting the hot gas load towards the new waste boiler E002 and utilizing this heat to produce more steam.

### 9) Better Control of Shift Reactor Inlet Temperature

In the new process the inlet temperature of a reactor R002, such as a shift reactor, can be increased by controlling the flow to stream 4200 or by using the optional internal bypass of new waste heat boiler E002, thus providing a better control of the inlet temperature of shift reactor R002.

### EXAMPLE

Comparison of New Heat Exchange Reforming Layout (FIG. 3) with Conventional 2 Step Reforming Layout and Conventional Heat Exchange Reforming Layout (FIG. 2).

A 1930 MTPD, 2 step reforming based ammonia production plant has been in operation for the last 40 years and comprises a 2 step reforming layout with a primary reformer and a secondary reformer. Table 1 below shows the comparison of three different designs, C1, C2 and C3, when these are introduced as a revamp option.

### Basis for the Evaluation:

1) Plant production has been considered similar in all cases C1, C2 and C3;
2) Feed, fuel and other utility compositions and conditions considered approximate in all cases C1, C2 and C3;
3) Minimum CO₂ production requirement from the plant has been considered approximate in all cases C1, C2 and C3.

In Case C1 has been considered as a conventional 2 step reforming plant which also showcases the performance of existing plant (FIG. 1). In Case C2 it has been considered a layout where conventional heat exchange reforming is introduced as a revamp option (FIG. 2) and in Case 3 it has been considered the new process provided by the present invention, with conventional heat exchange reformer and a bypass through waste heat boiler 2, introduced as a revamp option (FIG. 3).

Results show that the new heat exchange reforming scheme represented in FIG. 3 provides the following advantages:
Approximately 2% lower feed consumption compared to conventional 2 step reforming layout (FIG. 1).
Approximately 12% lower fuel consumption compared to conventional 2 step reforming layout (FIG. 1).
Approximately 7% higher steam production compared to conventional heat exchange reforming layout (FIG. 2).
Approximately 50% lower methane slip compared to conventional 2 step reforming layout (FIG. 1).
Approximately 30% lower size of heat exchange reformer compared to conventional heat exchange reforming layout (FIG. 2).
Approximately 2% lower pressure drop compared to conventional heat exchange reforming layout (FIG. 2).

TABLE 1

| | | | | | Overall | Methane | | | |
|---|---|---|---|---|---|---|---|---|---|
| | | | | | steam | slip inlet | | Overall | |
| | | | NG | NG fuel | production | of First | Heat | pressure | |
| | | Ammonia | Feed | flow to | from the | shift | exchange | drop in the | CO2 |
| | Case | production | flow | reformer | front end | reactor | reformer | front end | production |
| Cases | description | MTPD | Nm3/h | Nm3/h | tons/h | dry mole % | size | kg/cm2 | Nm3/h |
| C1 | Conventional | 1930 | 45704 | 20532 | 333 | 0.5 | Not | 11.5 | 53139 |
| | 2 step | | | | | | applicable | | |
| | reforming | | | | | | | | |
| | scheme | | | | | | | | |
| | (FIG. 1) | | | | | | | | |
| C2 | Conventional | 1930 | 44872 | 17002 | 278 | 0.25 | 30% | 12.5 | 52805 |
| | heat exchange | | | | | | higher | | |
| | reformer | | | | | | than | | |
| | scheme | | | | | | case C3 | | |
| | introduced | | | | | | | | |
| | as revamp | | | | | | | | |
| | scheme | | | | | | | | |
| | (FIG. 2) | | | | | | | | |
| C3 | New heat | 1930 | 44860 | 18076 | 296 | 0.25 | 30% | 12.2 | 52802 |
| | exchange | | | | | | lower | | |
| | reformer | | | | | | than | | |
| | scheme | | | | | | case C2 | | |
| | introduced | | | | | | | | |
| | as revamp | | | | | | | | |
| | scheme | | | | | | | | |
| | (FIG. 3) | | | | | | | | |

1. A process to control an outlet temperature of a heat exchange reformer in syngas production for chemicals and fuels, wherein a first stream of feed gas is directed to a reforming section and a second stream of feed gas is directed to said heat exchange reformer, wherein an outlet stream of said reforming section is divided into at least two sub-streams including a first sub-stream and a second sub-stream, wherein:
a) the first sub-stream is directed into said heat exchange reformer to provide heat for reforming reaction and the outlet stream of the heat exchange reformer is directed to a first waste heat boiler; and
b) the second sub-stream bypasses the heat exchange reformer and is directed to a second waste heat boiler for heat recovery and high pressure steam production, the second waste heat boiler being configured for heat recovery and high pressure steam production,
wherein the outlet temperature of said heat exchange reformer is thereby adjusted.

2. The process according to claim 1, wherein the outlet temperature of the heat exchange reformer is between 500° C. and 900° C.

3. The process according to claim 1, wherein said syngas is for production of chemicals and fuels.

4. The process according to claim 1, wherein the reforming section comprises two-step reforming for production of ammonia.

5. The process according to claim 1, the process including controlling an inlet temperature of a reactor, wherein the outlet stream is directed to said reactor.

6. The process according to claim 5, wherein said reactor is a shift reactor.

7. A plant for production of chemicals and fuels configured for conducting a process according to claim 1, the plant comprising:
a) the reforming section;
b) the heat exchange reformer;
c) the first waste heat boiler; and
d) the second waste heat boiler,
wherein at least one control means, located on or downstream of at least one of the first or second waste heat boiler, is configured to adjust the outlet temperature at the heat exchange reformer.

8. The plant according to claim 7, for production of ammonia, wherein said reforming section comprises a secondary reformer downstream of a primary reformer, the heat exchange reformer being downstream of the secondary reformer.

9. The plant according to claim 7, wherein said control means is a valve downstream of the at least one of the first or second waste heat boiler.

10. The process according to claim 1, wherein said reforming section comprises a secondary reformer downstream of a primary reformer, the heat exchange reformer being downstream of the secondary reformer.

11. The process according to claim 1, wherein the second waste heat boiler produces high pressure steam.

12. The process according to claim 1, wherein a total flow of the second sub-stream is 13% to 15% of a total flow of the outlet stream.
